(19) United States
(12) Patent Application Publication
(10) Pub. No.: US 2007/0269120 A1
(43) Pub. Date: Nov. 22, 2007

(54) VIDEO IMAGE COMPRESSION USING MODEL PLUS DIFFERENCE IMAGE

(75) Inventor: Michael S. Thiems, Elgin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/383,784

(22) Filed: May 17, 2006

(51) Int. Cl. G06K 9/36

(52) U.S. Cl. 382/238

(57) ABSTRACT

A compressed digital representation of an original image, or sequence of images, that includes compressed model parameters and a compressed digital representation of a difference image. The model parameters describe the image with reference to a model. The difference image is formed as a difference between the original image and a synthetic image rendered from the model parameters. The compressed digital representation may be generated by an encoder and the original image or sequence of images may be recovered by a decoder.

### BACKGROUND

Digital video and digital images contain very large amounts of information. For example, digital cameras that capture still images having five million pixels or more are common place. Digital video displays involve large numbers of image frames that are played or rendered successively at rates of between 10 and 60 frames per second. Each image frame is a still image formed from an array of pixels according to the display resolution of a particular system. As examples, NTSC-based systems have display resolutions of 720×486 pixels and high-definition television (HDTV) systems have display resolutions of 1920×1080 pixels. Video sequences contain very large amounts of raw digital information. For example, with reference to a digitized form of a digitized NTSC image format having a 720×486 pixel resolution and 45 frames per second, a full-length motion picture of two hours in duration could correspond to 113 gigabytes of digital video information.

In response to the limitations in storing or transmitting such massive amounts of digital information, various image and video compression standards or processes have been established.

Image compression techniques include techniques described in the Joint Picture Expert Group (JPEG) standards JPEG and JPEG2000 and the GIF standard. Video compression techniques are described in the Motion Picture Expert Group (MPEG) standards (e.g., MPEG-1, MPEG-2, MPEG-4) and ITU-T standards H.263 and H264. The conventional video compression techniques utilize similarities within image frames, referred to as spatial or intra-frame correlation, to provide intra-frame compression. Intra-frame compression is based upon conventional processes for compressing still images, such as discrete cosine transform (DCT) encoding. In addition, these conventional video compression techniques utilize similarities between successive image frames, referred to as temporal or inter-frame correlation, to provide inter-frame compression in which pixel-based representations of image frames are converted to motion representations.

MPEG-4 describes a format for representing video in terms of objects and backgrounds, but stops short of specifying how the background and foreground objects are to be obtained from the source video. An MPEG-4 visual scene may consist of one or more video objects or models. Each video model is characterized by temporal and spatial information in the form of shape, motion, and texture. In particular, MPEG-4 includes the ability to render synthetic people and faces from a minimal set of animation parameters. A related area is vision-based control of 2D and 3D animations. Here, a video sequence is again used to derive parameters that control an animation model.

MPEG-4, in common with most 3-dimensional (3D) rendering standards such as OpenGL and DirectX, does not standardize a bit-exact rendering output match. That is, the standards do not rigorously specify every internal detail of a rendering implementation.

Model-base video compression provides a very high compression ratio. However, a disadvantage is that images rendered from 2D or 3D models appear unnatural or synthetic. This is particularly true when the images are faces or people.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is block diagram of an image/video encoding and decoding system in accordance with certain embodiments of the invention.

FIG. 2 is block diagram of an image/video encoder in accordance with certain embodiments of the invention.

FIG. 3 is block diagram of an image/video decoder in accordance with certain embodiments of the invention.

FIG. 4 is a flow chart of a method for image/video encoding in accordance with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

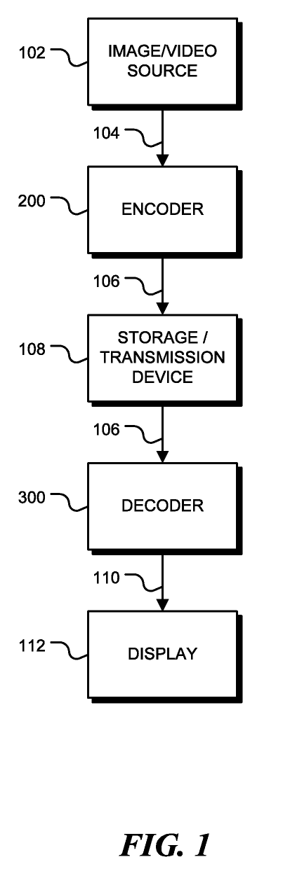

FIG. 1 is block diagram of an image/video encoding and decoding system in accordance with certain embodiments of the invention. Referring to FIG. 1, the system 100 includes an image/video source 102, such as a camera or digital storage device that provides a data stream 104 of raw or uncompressed data. The data stream 104 is input to encoder 200. The encoder 200 compresses (encodes) the data stream to produce an encoded data stream 106. The encoded data stream is a compressed digital representation of the original image. The aim of the compression is to reduce the amount of data used to describe the image or sequence of images. The encoded data stream 106 may be stored for future display or transmitted over a communication link using a storage or transmission device 108. After being stored or transmitted, the encoded data stream 106 is input to a decoder 300. The decoder 300 decompresses (decodes) the encoded data stream 106 to recover a decoded data stream 110 that approximates the original data stream 104. The quality of the decoded image or sequence of images is determined by how closely the decoded data stream 110 matches the original data stream 104. The decoded image may be displayed on a display 112.

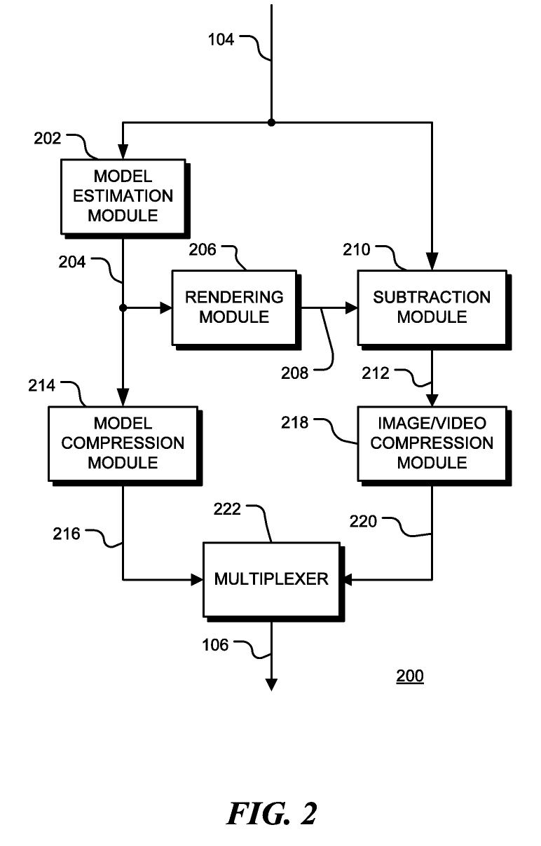

FIG. 2 is block diagram of an image/video encoder 200 in accordance with certain embodiments of the invention. The image/video encoder 200 receives a data stream 104 corresponding to an image or a sequence of images. The data stream 104 describing an original image is passed to a model estimation module 202 that analyzes the image to determine model parameters 204 for a specified model. For a face model, for example, the model parameters may include the size, position and orientation of the face, the positions of the eyes, nose and mouth, etc. From these model parameters 204, a rendering module 206 produces a synthetic image 208. The synthetic image 208 is an approximation of the original, uncompressed, image. The operation of the rendering module is specified, so that the image rendered from a particular set of model parameters is determined uniquely. The difference 212 between the synthetic image 208 and the original image 104 is computed in subtraction module 210. The difference may be calculated on a pixel-by-pixel basis.

The model parameters 204 are also input to a model compression module 214 where they are compressed using known techniques, to form compressed model parameters 216. In one embodiment of the invention, no parameter compression is performed, so the compressed model parameters are the model parameters themselves.

The difference image 212 is input to an image/video compression module 218. Various image/video compression modules, such as those described above, are well known to those of ordinary skill in the art. Other image/video compression modules may be used without departing from the present invention. Video compression may use information from previous images in the sequence of images (inter-frame information). A compressed difference image 220 is output from the image/video compression module 218. Generally, the difference image 212 contains substantially fewer components at high spatial frequencies than the original image and has a lower dynamic range. Thus, the difference image 212 can be compressed more efficiently than the original image.

Finally, the compressed model parameters 216 and the compressed difference image 220 are multiplexed together in multiplexer 222 to form the final compressed data stream 106.

The use of a model provides increased compression ratios, while the use of a difference image provides for more natural (higher quality) decompressed images.

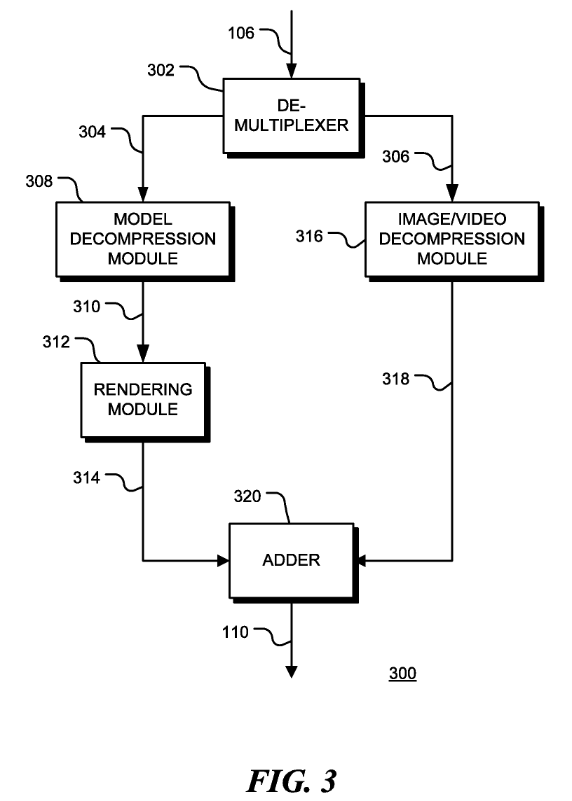

FIG. 3 is block diagram of an image/video decoder 300 in accordance with certain embodiments of the invention. Referring to FIG. 3, the compressed data stream 106 is input to a de-multiplexer 302 that splits the data stream into compressed model parameters 304 and compressed difference image parameters 306. The compressed model parameters 304 are passed to a model decompression module 308 that recovers the model parameters 310. The module parameters 312 are used by rendering module 312 to generate a synthetic image 314. The operation of the rendering module 312 is the same as that of the rendering module 206 of the encoder.

The compressed difference image parameters 306 are input to image/video decompression module 316 that recovers a difference image 318.

The difference image 318 and the synthetic image 314 are added in adder 320 to produce an estimate 110 of the original image.

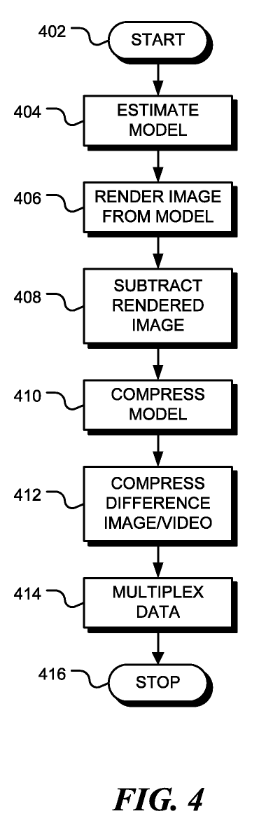

FIG. 4 is a flow chart of a method for image/video encoding in accordance with certain embodiments of the invention. Following start block 402, an encoder receives an image or a sequence of images and estimates model parameters at block 404. From these model parameters, a synthetic image is rendered at block 406. The synthetic image is an approximation of the original, uncompressed, image. The operation of the rendering module is specified, so that the image rendered from a particular set of model parameters is determined uniquely. At block 408 the difference between the synthetic image and the original image is computed by subtracting the rendered image from the original image (or vice versa). The model parameters are compressed at block 410, using known techniques, to form compressed model parameters. The difference image is compressed at block 412. Various image/video compression modules, such as those described above, are well known to those of ordinary skill in the art. Video compression may use information from previous images in the sequence of images (inter-frame information). At block 414 the compressed model parameters and the compressed difference image are multiplexed together to form the final compressed digital representation of the image.

Image/video coding and decoding has application in many areas, including video telephones, mobile telephones, video/still cameras and video transmission over networks.

The encoder and/or decoder may be implemented using general or special purpose hardware and/or dedicated processors, such as general purpose computers, microprocessor based computers, digital signal processors, microcontrollers, dedicated processors, custom circuits, ASICS and/or dedicated hard wired logic.

The encoder and/or decoder may be implemented in software as a sequence of programming steps to be executed on a processor. The software may be recorded on computer readable media such as, for example, disc storage, Read Only Memory (ROM) devices, Random Access Memory (RAM) devices, optical storage elements, magnetic storage elements, magneto-optical storage elements, flash memory and/or other equivalent storage technologies without departing from the present invention. Such alternative storage devices should be considered equivalents.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A compressed digital representation of an original image comprising:
a digital representation of a plurality of model parameters of a model of the original image; and
a compressed digital representation of a difference image formed from a difference between the original image and a synthetic image rendered from the plurality of model parameters.

2. A compressed digital representation in accordance with claim 1, wherein the digital representation of the plurality of model parameters and the compressed digital representation of the difference image are multiplexed to form a data stream.

3. A compressed digital representation in accordance with claim 1, wherein the original image is an image from a sequence of images and wherein the compressed digital representation of difference image is dependent upon one or more difference images formed from previous images of the sequence of images.

4. An encoder operable to generate a compressed digital representation in accordance with claim 1 comprising:
a model estimation module operable to analyze the original image to produce the plurality of model parameters;
a rendering module operable to form the synthetic image from the model parameters;
a subtraction module operable to produce the difference image that is the difference between the synthetic image and the original image; and
a first compression module operable to compress the difference image to form the compressed digital representation of the difference image.

5. An encoder in accordance with claim 4, further comprising a second compression module operable to compress the plurality of model parameters to form the digital representation of the plurality of model parameters.

6. An encoder in accordance with claim 5, further comprising a multiplexer operable to combine the digital representation of the plurality of model parameters and the compressed digital representation of the difference image to form a data stream.

7. A decoder operable to decode a compressed digital representation in accordance with claim 1 comprising:
a first decompression module operable to decode the compressed digital representation of the difference image to form a decoded difference image;
a second decompression module operable to decode the digital representation of the plurality of model parameters to recover the plurality of model parameters.
a rendering module operable to form a synthetic image from the plurality of model parameters; and
an adder operable to add the decoded difference image and the synthetic image to form a decoded image.

8. A decoder in accordance with claim 7, further comprising:
a demultiplexer operable to recover the digital representation of the plurality of model parameters and the compressed digital representation of the difference image from a data stream,
wherein the data stream comprises the digital representation of the plurality of model parameters multiplexed with the compressed digital representation of the difference image.

9. A method for encoding an original digital image to form a compressed digital image, the method comprising:
analyzing the digital image to determine model parameters of a model of the image;
rendering a synthetic image from the model parameters;
subtracting the original digital image and the synthetic image to produce a difference image;
compressing the difference image to form a compressed difference image; and
combining the model parameters and the compressed difference image to form the compressed digital image.

10. A method in accordance with claim 9, wherein combining the model parameters and the compressed difference image to form the compressed digital image comprises compressing the model parameters to form compressed model parameters.

11. A method in accordance with claim 10, wherein combining the model parameters and the compressed difference image to form the compressed digital image further comprises multiplexing the compressed model parameters and the compressed difference image to form a data stream.

12. A computer readable medium containing computer instructions which when executed on a computer perform the method of claim 9.

13. A method for decoding a compressed digital image to recover an estimate of an original digital image, the method comprising:
recovering model parameters from the compressed digital image;
rendering a synthetic image from the model parameters;
recovering a compressed difference image from the compressed digital image;
decompressing the compressed difference image to recover a difference image; and
adding the difference image and the synthetic image to produce the estimate of the original digital image.

14. A method in accordance with claim 13, wherein recovering model parameters from the compressed digital image comprises:
recovering compressed model parameters from the compressed digital image; and
decoding the compressed model parameters to recover the model parameters.

15. A method in accordance with claim 14, wherein recovering compressed model parameters from the compressed digital image further comprises de-multiplexing a data stream comprising the compressed model parameters multiplexed with the compressed difference image.

16. A computer readable medium containing computer instructions which when executed on a computer perform the method of claim 13.

17. An image encoder operable to produce a compressed digital representation of an original image, the image encoder comprising:
an analysis means for analyzing the original image to determine model parameters of a model of the image;
a rendering means for producing a synthetic image from the model parameters;
a subtraction means for calculating a difference image as the difference between the synthetic image and the original image;
a first compression means for compressing the difference image to form a compressed difference image; and
combining means for combining the model parameters and the compressed difference image to form the compressed digital representation of the original image.

18. An image encoder in accordance with claim 17, wherein the combining means comprises:
a second compression means for compressing the model parameters to produce compressed model parameters; and
a multiplexing means for multiplexing the compressed model parameters and the compressed digital representation.

19. An image decoder for decoding a compressed digital representation, the image decoder comprising:
a recovery means for recovering a compressed difference image and a plurality of model parameters from the compressed digital representation;
a first decompression means for decoding the compressed difference image to form a decoded difference image;
a rendering means for forming a synthetic image from the plurality of model parameters; and
a means for adding the decoded difference image and the synthetic image to form a decoded image.

20. An image decoder in accordance with claim 19, wherein the recovery means comprises:
a de-multiplexing means for recovering a plurality of compressed model parameters and the compressed digital representation of the difference image from the compressed digital representation; and
a second decompression means for decoding the compressed model parameters to recover the plurality of model parameters.
